(19) United States
(12) Patent Application Publication
(10) Pub. No.: US 2011/0164856 A1
(43) Pub. Date: Jul. 7, 2011

(54) PORTABLE RECORDING/REPRODUCING APPARATUS

(75) Inventor: Yoshiyuki TAKAGI, Nagoya-shi (JP)

(73) Assignee: Buffalo Inc., Nagoya-shi (JP)

(21) Appl. No.: 12/983,479

(22) Filed: Jan. 3, 2011

(30) Foreign Application Priority Data
Jan. 5, 2010 (JP) 2010-000768

(51) Int. Cl. H04N 5/765

(52) U.S. Cl. 386/234; 386/E05.003

(57) ABSTRACT

A portable recording/reproducing apparatus has a function of a remote controller and a function of controlling a recording medium. The portable recording/reproducing apparatus includes an operation unit on which an operation relating to reproduction of a video content is performed, a video content reproducing unit configured to reproduce the video content in response to the operation relating to the reproduction performed on the operation unit, and a transmission processor configured to wirelessly send a display apparatus the video content reproduced by the video content reproducing unit as a control signal.

### CROSS REFERENCE TO RELATED APPLICATIONS

This application is based upon and claims the benefit of priority from prior Japanese Patent Application No. 2010-000768, filed on Jan. 5, 2010; the entire contents of which are incorporated herein by reference.

### BACKGROUND OF THE INVENTION

1. Field of the Invention

The present invention relates to a portable recording/reproducing apparatus having a function of a remote controller and a function of controlling a recording medium.

2. Description of the Related Art

Non-portable recording/reproducing apparatuses for portable recording media, such as a Blu-ray Disc and a digital versatile disc (DVD), and non-portable recording/reproducing apparatuses for internal recording media, such as a hard disk drive (HDD), are widely used recently. Almost all of such non-portable recording/reproducing apparatuses are supposed to be operated by a remote controller. Meanwhile, a technique for wirelessly communicating video signals between the non-portable recording/reproducing apparatus and a display apparatus such as a television set or a monitor is becoming common.

Also, a technique is proposed in which a remote controller performs some of the functions of an apparatus operated by using the remote controller, although this remote controller is not for operating a non-portable recording/reproducing apparatus (for example, Japanese Unexamined Patent Application Publication No. 2002-10100).

In the above-described technique, a display panel provided in the remote controller displays a list of titles relating to the contents of teletext broadcasting which is normally displayed on a display apparatus such as a television set or a monitor. Then, when the user selects a title relating to a desired content of the teletext broadcasting from the list of titles, the content of the teletext broadcasting is reproduced as audio data by, for example, a speaker provided in the remote controller.

The remote controller according to the above-described technique is capable of performing some of the functions of the apparatus operated by using the remote controller. However, for example, in a case of a non-portable recording/reproducing apparatus, replacement of portable recording media and the like cannot be performed in a remote operation using the remote controller. Instead, a user has to move to a position where the user can directly operate the non-portable recording/reproducing apparatus, and directly operate the non-portable recording/reproducing apparatus.

### SUMMARY OF THE INVENTION

According to a first aspect of the present invention, there is provided a portable recording/reproducing apparatus having a function of a remote controller and a function of controlling a recording medium. The portable recording/reproducing apparatus includes an operation unit on which an operation relating to reproduction of a video content is performed, a video content reproducing unit for reproducing the video content in response to the operation relating to the reproduction performed on the operation unit, and a transmission processor for wirelessly sending a display apparatus the video content reproduced by the video content reproducing unit as a control signal.

According to such portable recording/reproducing apparatus, the operations of the portable recording/reproducing apparatus can be remotely operated in the palm of user's hand.

According to a second aspect of the present invention, there is provided a portable recording/reproducing apparatus according to the first aspect of the invention, wherein the transmission processor compresses the video content reproduced by the video content reproducing unit, and then sends the video content thus compressed to the display device as the control signal.

According to a third aspect of the present invention, there is provided a portable recording/reproducing apparatus according to the first aspect of the invention, wherein the video content reproducing unit reproduces the video content stored in the recording medium.

According to a fourth aspect of the present invention, there is provided a portable recording/reproducing apparatus according to the first aspect of the invention, further including a first video content receiver for receiving the video content, wherein the video content reproducing unit reproduces the video content received by the first video content receiver.

According to a fifth aspect of the present invention, there is provided a portable recording/reproducing apparatus according to the first aspect of the invention, further including a second video content receiver for receiving the video content; and a video content connector configured so that the second video content receiver is connected to the video content connector, wherein the video content reproducing unit reproduces the video content received by the second video content receiver.

According to a sixth aspect of the present invention, there is provided a portable recording/reproducing apparatus according to the first aspect of the invention, further including a third video content receiver configured to receive the video content directly or through a network from another apparatus having a function of controlling the recording medium, wherein the video content reproducing unit reproduces the video content received by the third video content receiver.

According to a seventh aspect of the present invention, there is provided a portable recording/reproducing apparatus according to the first aspect of the invention, wherein the operation unit on which an operation relating to recording of the video content is performed; and further comprising: a video content recorder for recording the video content in the recording medium in response to the operation relating to the recording performed on the operation unit.

### BRIEF DESCRIPTION OF THE DRAWINGS

FIG. 1 is an overall schematic configuration diagram of a communication system according an embodiment of the present invention.

FIG. 2 is a configuration diagram of a Wireless HD recording/reproduction controller according to the embodiment of the present invention.

FIG. 3 is a flowchart showing a first operation of the Wireless HD recording/reproduction controller according to the embodiment of the present invention.

FIG. 4 is a flowchart showing a second operation of the Wireless HD recording/reproduction controller according to the embodiment of the present invention.

FIG. 5 is a flowchart showing a third operation of the Wireless HD recording/reproduction controller according to the embodiment of the present invention.

### DETAILED DESCRIPTION OF THE EMBODIMENTS

Embodiments of the present invention are described with reference to the drawings. Specifically, description is given of (1) Overall Schematic Configuration of Communication System, (2) Configuration of Wireless HD Recording/reproduction controller, (3) Operations of Wireless HD Recording/reproduction controller, (4) advantageous effects, and (5) Other Embodiments. In the drawings of the embodiments described below, same or similar components are denoted with same or similar reference numerals. Note that, in this embodiment, a Wireless HD recording/reproduction controller 10 and a Wireless HD television set 20 to be described later are in conformity with Wireless HD being a standard for performing communication between home appliances and AV equipments by radio transmission of uncompressed data in the 60 GHz frequency band.

### (1) Overall Schematic Configuration of Communication System

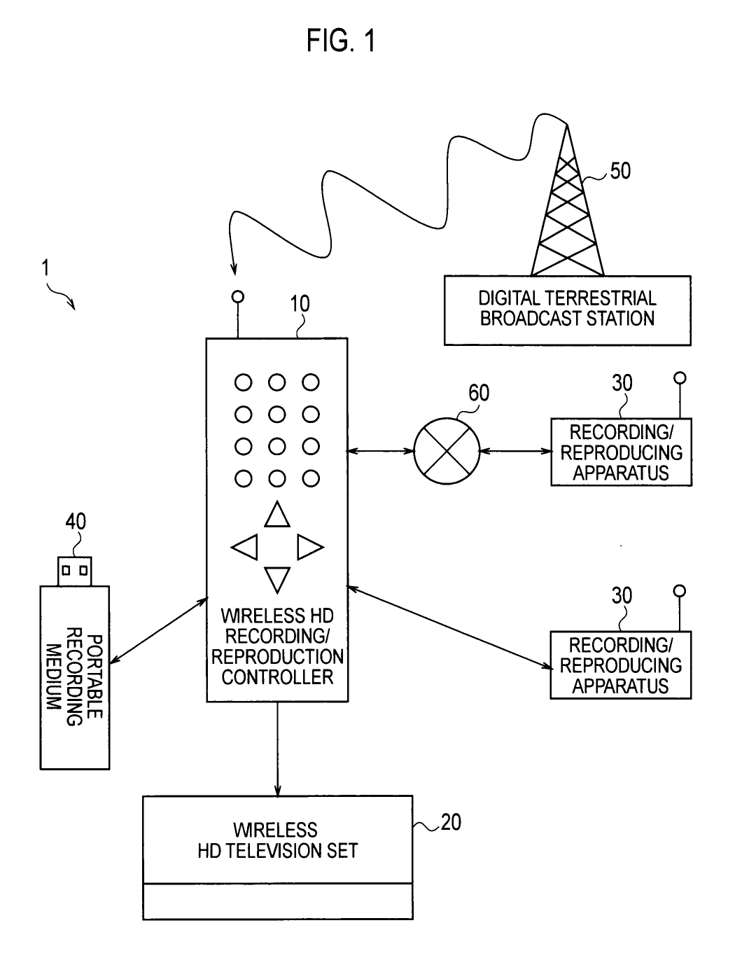

FIG. 1 is an overall schematic configuration diagram of a communication system 1 according to the embodiment of the present invention.

As shown in FIG. 1, the communication system 1 includes the Wireless HD recording/reproduction controller 10, the Wireless HD television set 20, a recording/reproducing apparatus 30, a portable recording medium 40, a digital terrestrial broadcast station 50, and a network 60 such as the Internet and a LAN.

The Wireless HD recording/reproduction controller 10 acquires video contents from a storage unit 700 described below. Alternatively, the Wireless HD recording/reproduction controller 10 receives video contents from the recording/reproducing apparatus 30 directly connected thereto or from the recording/reproducing apparatus 30 via the network 60. The Wireless HD recording/reproduction controller 10 acquires video contents from the portable recording medium 40 directly connected thereto. The Wireless HD recording/reproduction controller 10 receives video contents from the digital terrestrial broadcast station 50. Thereafter, a HD encoder 300 described below of the Wireless HD recording/reproduction controller 10 encodes the acquired or received video contents. The Wireless HD recording/reproduction controller 10 wirelessly sends the Wireless HD television set 20 the encoded video contents via Wireless HD unit 200 described below. Alternatively, the Wireless HD recording/reproduction controller 10 records or stores the video contents acquired or received from the outside of the Wireless HD recording/reproduction controller 10 in the later-described storage unit 700. Note that, the Wireless HD recording/reproduction controller 10 has a similar size to a common remote controller of a non-portable recording/reproducing apparatus in this embodiment.

The Wireless HD television set 20 wirelessly receives the HD encoded video contents from the Wireless HD recording/reproduction controller 10. Then an HD decoder of the Wireless 11D television set 20 decodes the received video contents. The Wireless HD television set 20 displays the decoded video contents on a display screen.

The recording/reproducing apparatus 30 sends the video contents to the Wireless HD recording/reproduction controller 10 directly connected thereto, or to the Wireless HD recording/reproduction controller 10 via the network 60. Note that, the recording/reproducing apparatus 30 includes a media server that delivers the video contents, a non-portable recording/reproducing apparatus of removable media such as a Blu-ray Disc or a DVD and of internal recording media such as an HDD, and the like.

The portable recording medium 40 is directly connected to the Wireless HD recording/reproduction controller 10, and allows the Wireless HD recording/reproduction controller 10 to use the video contents. Note that, the portable recording medium 40 includes a SD memory card, a Universal Serial Bus (USB) flash drive, and the like.

The digital terrestrial broadcast station 50 delivers digital broadcast.

(2) Configuration of Wireless HD Recording/reproduction controller

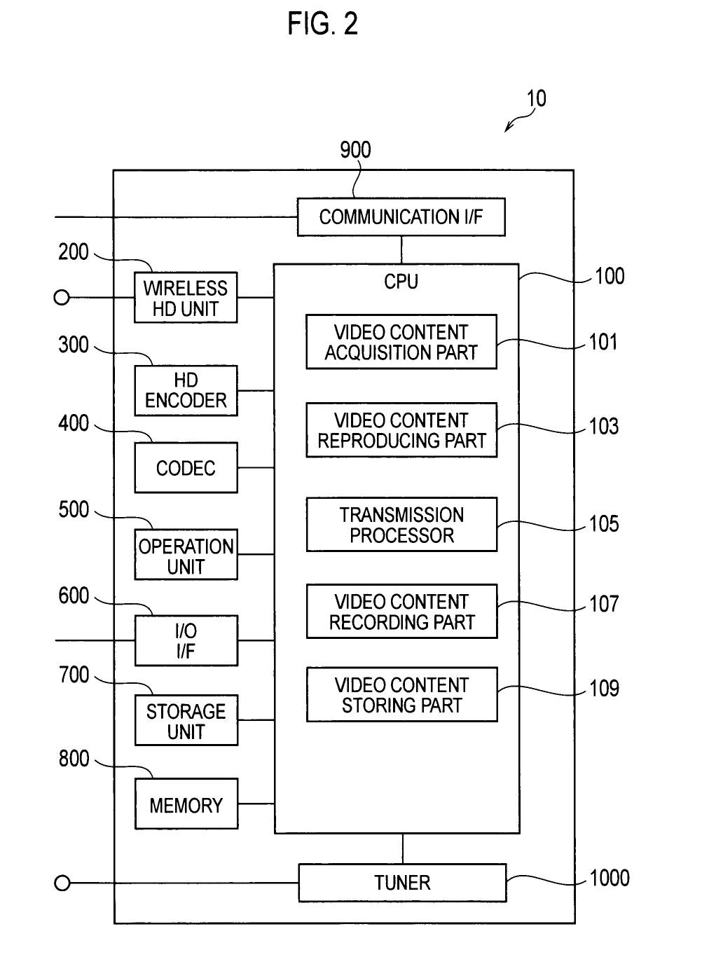

FIG. 2 is a configuration diagram of the Wireless HD recording/reproduction controller 10 according to the embodiment of the present invention.

The Wireless HD recording/reproduction controller 10 includes a CPU 100, the Wireless HD unit 200, the HD encoder 300, a codec 400, an operation unit 500, an I/O I/F 600, the storage unit 700, a memory 800, a communication I/F 900, and a tuner 1000.

The CPU 100 controls various functions provided to the Wireless HD recording/reproduction controller 10.

The Wireless HD unit 200 is an interface for wirelessly sending the Wireless HD television set 20 the video contents encoded by the later-described HD encoder 300 as control signals for the Wireless HD television set 20.

The HD encoder 300 encodes the video contents in accordance with Wireless HD which is a standard for connecting home appliances and AV devices by use of wireless communication.

The codec 400 encodes and decodes the video contents. Specifically, the codec 400 compresses or expands the video contents stored in the later-described storage unit 700 and the portable recording medium 40 directly connected to the Wireless 11D recording/reproduction controller 10 in accordance with a lossy compression standard for moving images such as MPEG-2 and H.264. Moreover, the codec 400 decodes the video contents which are received by the tuner 1000 from the digital terrestrial broadcast station 50 and are encrypted based on the B-CAS method. Note that. the standards which the codec 400 can use to encode and decode the video contents are not limited to the above-described MPEG-2, H.264, and the B-CAS method.

The operation unit 500 includes buttons and the like provided on the Wireless HD recording/reproduction controller 10, and is used for input of operation contents by a user.

The I/O I/F 600 is an interface for directly connecting the recording/reproducing apparatus 30 and the portable recording medium 40 to the Wireless HD recording/reproduction controller 10. The I/O I/F 600 also directly receives the video contents from the recording/reproducing apparatus 30.

The storage unit 700 includes, for example, an HDD or a solid state drive (SSD), and stores the video contents to be sent to the Wireless HD television set 20.

The memory 800 includes, for example, a flash memory or a random access memory (RAM), and stores various types of information used for controlling the Wireless HD recording/reproduction controller 10.

The communication I/F 900 receives the video contents from the recording/reproducing apparatus 30 via the network 60. Note that, the communication I/F 900 described as a wired I/F in this embodiment can also be a wireless I/F.

The tuner 1000 receives the video contents from the digital terrestrial broadcast station 50 selected by the user using the operation unit 500. In the present embodiment, the tuner 1000 is built into the Wireless HD recording/reproduction controller 10. However, the tuner 1000 may be provided outside the Wireless HD recording/reproduction controller 10 and be connected to the Wireless HD recording/reproduction controller 10. Moreover, in the present embodiment, the tuner 1000 receives radio signals. However, the tuner 1000 may receive signals transmitted by wires.

The CPU 100 includes a video content acquisition part 101, a video content reproducing part 103, a transmission processor 105, a video content recording part 107, and a video content storing part 109.

The video content acquisition part 101 acquires the video contents stored in the storage unit 700. Alternatively, the video content acquisition part 101 acquires the video contents stored in the portable recording medium 40 directly connected to the I/O I/F 600. Alternatively, the video content acquisition part 101 acquires the video contents which the I/O I/F 600 has received directly from the recording/reproducing apparatus 30. Alternatively, the video content acquisition part 101 acquires the video contents which the communication I/F 900 has received from the recording/reproducing apparatus 30 through the network 60. Alternatively, the video content acquisition part 101 acquires the video contents which the tuner 1000 has received from the digital terrestrial broadcast station 50 selected by the user using the operation unit 500.

The video content reproducing part 103 decodes the video contents to be reproduced that is acquired by the video content acquisition part 101 by using the codec 400, and then reproduces the video contents. Specifically, the video content reproducing part 103 expands the video contents compressed in MPEG-2 or H.264 by using the codec 400, and then reproduces the video contents. The video content reproducing part 103 also decodes the video contents encrypted based on the B-CAS method by using the codec 400, and then reproduces the video contents. Note that, only when some type of encoding is performed on the video contents which the I/O I/F 600 has received directly from the recording/reproducing apparatus 30 among the video contents which the video content acquisition part 101 has acquired from the I/O I/F 600 and on the video contents which the video content acquisition part 101 has acquired from the communication I/F 900, the video content reproducing part 103 performs appropriate decoding on such video contents by using the codec 400. Thereafter, the video content reproducing part 103 reproduces the video contents in any cases.

The transmission processor 105 encodes the video contents reproduced by the video content reproducing part 103 in accordance with Wireless HD by using the HD encoder 300. Then, the transmission processor 105 wirelessly sends the Wireless HD television set 20 the encoded video contents as the control signals for the Wireless HD television set 20 through the Wireless 11D unit 200.

The video content recording part 107 performs decoding by using the codec 400 on the video contents received by the tuner 1000 among the video contents acquired by the video content acquisition unit 101 for recording, the decoding being that for the video contents encrypted based on the B-CAS method. Thereafter, the video content recording part 107 performs compression in accordance with MPEG-2 or H.264 on the decoded video contents by using the codec 400, and then records the compressed video contents in the storage unit 700. Note that, only when some type of encoding is performed on the video contents which the I/O I/F 600 has directly received from the recording/reproducing apparatus 30 and on the video contents received by the communication I/F 900 among the video contents acquired by the video content acquisition part 101 for recording, the video content recording part 107 performs appropriate decoding on such video contents by using the codec 400. Thereafter, the video content recording part 107 performs compression in accordance with MPEG-2 or H.264 on the decoded video contents by using the codec 400, and then records the compressed video contents in the storage unit 700 in both cases. Note that, the video content recording part 107 may record the compressed video contents in the portable recording medium 40 directly connected to the I/O I/F 600 instead of in the storage unit 700.

The video content storing part 109 stores the video contents compressed in accordance with MPEG-2 or H.264 in the storage unit 700. The video contents having been acquired by the video content acquisition part 101 for storing from the portable recording medium 40, directly connected to the I/O I/F 600, where the video contents had been stored. Moreover, the video content storing part 109 may store the video contents compressed in accordance with MPEG-2 or H.264 in the portable recording medium 40 directly connected to the I/O I/F 600. The video contents having been acquired by the video content acquisition part 101 for storing and having been stored in the storage unit 700.

### (3) Operations of Wireless HD Recording/Reproduction Controller

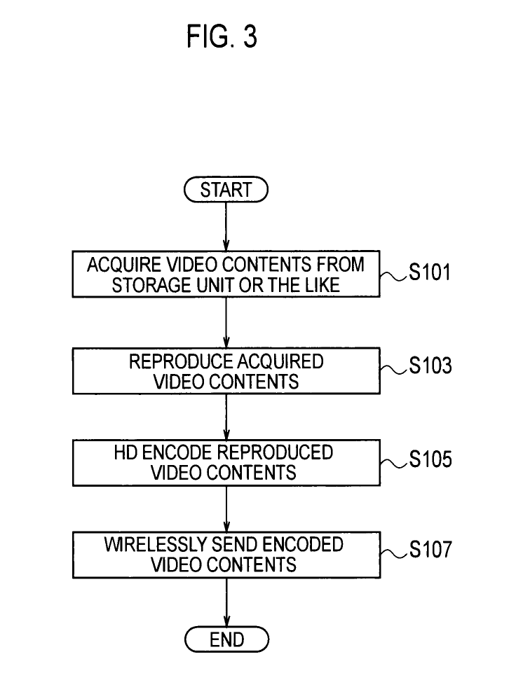

Next, operations of the Wireless HD recording/reproduction controller 10 are described. FIGS. 3 to 5 are flowcharts showing the operations of the Wireless HD recording/reproduction controller 10.

First, the operation in which the Wireless HD recording/reproduction controller 10 reproduces the video contents is described by using FIG. 3.

In step S101, the video content acquisition part 101 acquires the video contents stored in the storage unit 700. Alternatively, the video content acquisition part 101 acquires the video contents stored in the portable recording medium 40 directly connected to the I/O I/F 600. Alternatively, the video content acquisition part 101 acquires the video contents which the I/O I/F 600 has directly received from the recording/reproducing apparatus 30. Alternatively, the video content acquisition part 101 acquires the video contents which the communication I/F 900 has received from the recording/reproducing apparatus 30 through the network 60. Alternatively, the video content acquisition part 101 acquires the video contents which the tuner 1000 has received from the digital terrestrial broadcast station 50 selected by the user using the operation unit 500.

In step S103, the video content reproducing part 103 decodes the video contents acquired by the video content acquisition part 101 by using the codec 400, and then reproduces the video contents. Specifically, the video content reproducing part 103 expands the video contents compressed in MPEG-2 or H.264 by using the codec 400, and then reproduces the video contents. Alternatively, the video content reproducing part 103 decodes the video contents encrypted based on the B-CAS method by using the codec 400, and then reproduces the video contents. Note that, only when some type of encoding is performed on the video contents which the I/O I/F 600 has received directly from the recording/reproducing apparatus 30 among the video contents which the video content acquisition part 101 has acquired from the I/O I/F 600 and on the video contents which the video content acquisition part 101 has acquired from the communication I/F 900, the video content reproducing part 103 performs appropriate decoding on such video contents by using the codec 400. Thereafter, the video content reproducing part 103 reproduces the video contents in any cases.

In step S105, the transmission processor 105 encodes the video contents reproduced by the video content reproducing part 103 in accordance with Wireless HD by using the HD encoder 300.

In step S107, the transmission processor 105 wirelessly sends the Wireless HD television set 20 the encoded video contents as the control signals for the Wireless HD television set 20 through the Wireless HD unit 200.

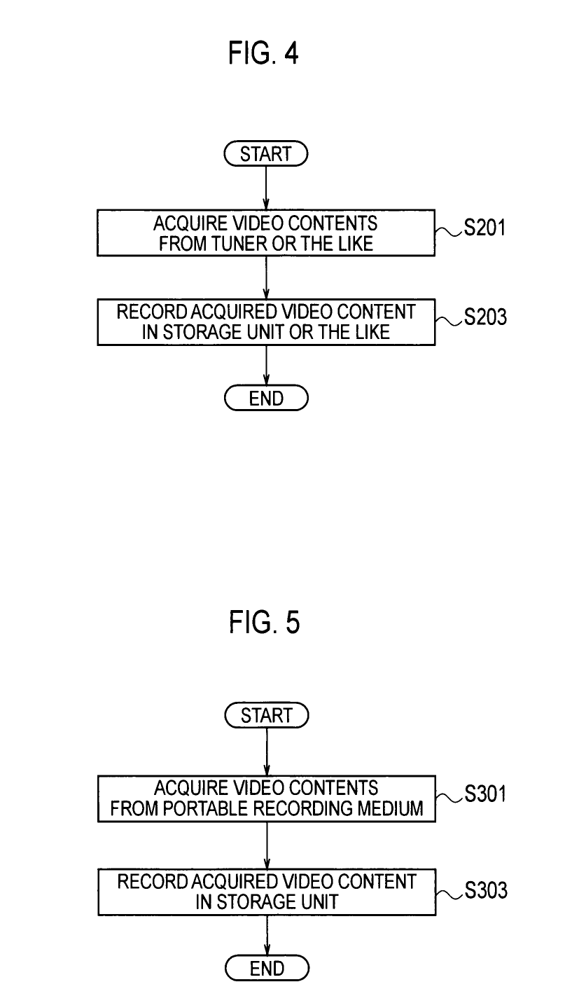

Next, the operation in which the Wireless HD recording/reproduction controller 10 records the video contents is described by using FIG. 4.

In step S201, the video content acquisition part 101 acquires the video contents which the I/O I/F 600 has directly received from the recording/reproducing apparatus 30. Alternatively, the video content acquisition part 101 acquires the video contents which the communication I/F 900 has received from the recording/reproducing apparatus 30 through the network 60. Alternatively, the video content acquisition part 101 acquires the video contents which the tuner 1000 has received from the digital terrestrial broadcast station 50 selected by the user using the operation unit 500.

In step S203, the video content recording part 107 performs decoding by using the codec 400 on the video contents received by the tuner 1000 among the video contents acquired by the video content acquisition part 101, the decoding being that for the video contents encrypted based on the B-CAS method. Thereafter, the video content recording part 107 performs compression in accordance with MPEG-2 or H.264 on the decoded video contents by using the codec 400, and then records the compressed video contents in the storage unit 700. Note that, only when some type of encoding is performed on the video contents which the I/O I/F 600 has directly received from the recording/reproducing apparatus 30 and on the video contents received by the communication I/F 900 among the video contents acquired by the video content acquisition part 101, the video content recording part 107 performs appropriate decoding on such video contents by using the codec 400. Thereafter, the video content recording part 107 performs compression in accordance with MPEG-2 or H.264 on the decoded video contents by using the codec 400 in any cases, and then records the compressed video contents in the storage unit 700.

Next, the operation in which the Wireless HD recording/reproduction controller 10 stores the video contents is described by using FIG. 5.

In step S301, the video content acquisition part 101 acquires the video contents stored in the portable recording medium 40 directly connected to the I/O I/F 600.

In step S303, the video content storing part 109 stores the video contents compressed in accordance with MPEG-2 or H.264 in the storage unit 700 in that state, the video contents having been acquired by the video content acquisition part 101 from the portable recording medium 40 directly connected to the I/O I/F 600 where the video contents had been stored.

### (4) Operation and Effect

In the embodiment of the present invention, the Wireless HD recording/reproduction controller 10 wirelessly sends the Wireless HD television set 20 the video contents encoded in accordance with Wireless HD as the control signals for displaying the video contents. Accordingly, the Wireless FID recording/reproduction controller 10 is configured to have a function of remote controller and a function of controlling a recording medium.

Moreover, in the embodiment of the present invention, the Wireless HD recording/reproduction controller 10 has a similar size to a common remote controller of a non-portable recording/reproducing apparatus.

According to such Wireless HD recording/reproduction controller 10, all the operations of the Wireless HD recording/reproduction controller 10 can be remotely operated by the user.

In addition, according to such Wireless HD recording/reproduction controller 10, since there is no need for a remote controller, the manufacturing cost and the like can be reduced.

Moreover, according to such Wireless HD recording/reproduction controller 10, a space saving effect can be expected by the downsizing of the Wireless HD recording/reproduction controller 10.

Furthermore, according to such Wireless HD recording/reproduction controller 10, each of family members can own a private Wireless HD recording/reproduction controller 10 in which a video content different from each other is stored.

### (5) Other Embodiments

The invention has been described according to the above embodiment. However, it should not be understood that the description and the drawings which are part of this disclosure limit this invention. Various alternative embodiments, examples, and operation techniques are apparent to those skilled in the art from this disclosure.

In the above-described embodiment, the Wireless HD recording/reproduction controller 10 and the Wireless HD television set 20 perform the transmission and the reception of the video contents in accordance with Wireless HD.

The transmission and the reception of the video contents may be performed in accordance with IEEE 802.15.3c and IEEE 802.11.ad which are standards for radio transmission using the 60 GHz frequency band which is the same frequency band as Wireless HD.

The transmission and the reception of the video contents may be performed in accordance with Wi-Fi (including 802.11a and 802.11n which use the 5 GHz frequency band and 802.11b, 802.11g, and 802.11n which use the 2.4 GHz frequency band) which is a communication standard for interconnectivity and the like between radio apparatuses.

The transmission and the reception of the video contents may be performed in accordance with wireless home digital interface (WHDI) which is a technique for performing short distance radio communication of high quality video contents in the 5 GHZ frequency band.

The transmission and the reception of the video contents may be performed in accordance with wireless high-definition multimedia interface (HDMI) which uses ultra wide band (UWB) being a radio communication method for performing wireless transmission and reception by spreading data over an extremely wide frequency band of several GHz, and which is an interface standard for home-use appliances and AV equipments to input and output digital video and audio.

In the above-described embodiment, no compressed video contents is transmitted and received between the Wireless HD recording/reproduction controller 10 and the Wireless HD television set 20. However, the compressed video contents may be transmitted and received between the Wireless HD recording/reproduction controller 10 and the Wireless HD television set 20.

In the above-described embodiment, the Wireless HD recording/reproduction controller 10 has a similar size to a common remote controller of a non-portable recording/reproducing apparatus. However, the Wireless HD recording/reproduction controller 10 may be smaller than such remote controller.

As described above, it should be understood that the present invention includes various embodiments and the like, which are not described herein. Accordingly, the present invention is limited only by the invention specifying matters of the scope of claims which are appropriate from the disclosure.

### INDUSTRIAL APPLICABILITY

The portable recording/reproducing apparatus of the present invention allows the user to remotely perform the operations of the recording/reproducing apparatus by including the function of the remote controller and the function of controlling the recording medium in the recording/reproducing apparatus, and is effective as a portable recording/reproducing apparatus.

What is claimed is:

1. A portable recording/reproducing apparatus having a function of a remote controller and a function of controlling a recording medium, the portable recording/reproducing apparatus comprising:
an operation unit on which an operation relating to reproduction of a video content is performed;
a video content reproducing unit for reproducing the video content in response to the operation relating to the reproduction performed on the operation unit; and
a transmission processor for wirelessly sending a display apparatus the video content reproduced by the video content reproducing unit as a control signal.

2. The portable recording/reproducing apparatus according to claim 1, wherein the transmission processor compresses the video content reproduced by the video content reproducing unit, and then sends the video content thus compressed to the display device as the control signal.

3. The portable recording/reproducing apparatus according to claim 1, wherein the video content reproducing unit reproduces the video content stored in the recording medium.

4. The portable recording/reproducing apparatus according to claim 1, further comprising a first video content receiver for receiving the video content, wherein
the video content reproducing unit reproduces the video content received by the first video content receiver.

5. The portable recording/reproducing apparatus according to claim 1, further comprising:
a second video content receiver for receiving the video content; and
a video content connector configured so that the second video content receiver is connected to the video content connector, wherein
the video content reproducing unit reproduces the video content received by the second video content receiver.

6. The portable recording/reproducing apparatus according to claim 1, further comprising a third video content receiver configured to receive the video content directly or through a network from another apparatus having a function of controlling the recording medium, wherein
the video content reproducing unit reproduces the video content received by the third video content receiver.

7. The portable recording/reproducing apparatus according to claim 1, wherein the operation unit on which an operation relating to recording of the video content is performed; and further comprising:
a video content recorder for recording the video content in the recording medium in response to the operation relating to the recording performed on the operation unit.
